(19) United States
(12) Patent Application Publication
(10) Pub. No.: US 2002/0070084 A1
(43) Pub. Date: Jun. 13, 2002

(54) Bicycle brake assembly with an anti-dead-lock device

(76) Inventor: Chin-Hwang Chou, Miaoli Hsien (TW)

Correspondence Address: TROP PRUNER & HU, PC, 8554 KATY FREEWAY, SUITE 100, HOUSTON, TX, 77024, US

(21) Appl. No.: 09/778,555

(22) Filed: Feb. 7, 2001

(30) Foreign Application Priority Data
Dec. 13, 2000 (TW) 089221647

(51) Int. Cl. B62L 1/00

(52) U.S. Cl. 188/24.11; 188/72.4; 188/24.22; 188/344

(57) ABSTRACT

A bicycle brake assembly includes a caliper body and an anti-dead lock device. The caliper body has a vertical passage to permit extension of a brake disk of a wheel, a fluid reservoir replete with a hydraulic fluid, and two brake-pad mounting pieces. Two brake pads are mounted respectively on the brake-pad mounting pieces of the caliper body, and are operably associated with the fluid reservoir in such a manner that when a pressure is applied on the fluid reservoir, the brake pads clamp the brake disk. The anti-lock device includes a cylinder defining a chamber, and a piston member disposed sealingly and movably in the chamber to divide the same into first and second partitions. The first partition is replete with the hydraulic fluid, and is in fluid communication with the fluid reservoir. An urging member is disposed in the second partition and abuts against the piston member. The piston member moves in a direction from the first partition toward the second partition when the pressure applied on the hydraulic fluid in the fluid reservoir overcomes an urging force provided by the urging member, thereby reducing an effective pressure acting on the hydraulic fluid in the fluid reservoir.

### BACKGROUND OF THE INVENTION

1. Field of the Invention

The invention relates to a bicycle brake assembly, more particularly to a bicycle brake assembly with an anti-dead-lock device.

2. Description of the Related Art

Referring to FIG. 1, a conventional bicycle brake assembly is shown to include a caliper body 1 and two brake pads 103. The caliper body 1 is adapted to be mounted on a front fork of a bicycle (not shown), and has a vertical passage 102 adapted to permit extension of a brake disk 2 of a front wheel of the bicycle (not shown) therein, a fluid reservoir 101 replete with a hydraulic fluid, and two brake-pad mounting pieces mounted on the caliper body 1 in such a manner that the brake-pad mounting pieces are adapted to be disposed on two sides of the brake disk 2. The brake pads 103 are mounted securely and respectively on the brake-pad mounting pieces of the caliper body 1, and are operably associated with the fluid reservoir 101 in such a manner that when a pressure is applied on the hydraulic fluid in the fluid reservoir 101 by virtue of actuation of a brake lever of the bicycle (not shown), the brake pads 103 will move toward each other so as to brake the brake disk 2 of the front wheel.

However, dead-lock of the brake pads 103 relative to the brake disk 2 of the front wheel may result in skidding of the wheel on the road or overturning of the bicycle in case the riding speed is relatively high.

### SUMMARY OF THE INVENTION

Therefore, the object of this invention is to provide a bicycle brake assembly with an anti-dead-lock device so as to prevent the occurrence of the above-stated drawbacks.

Accordingly, a bicycle brake assembly of the present invention is adapted to be mounted on a front fork of a bicycle for braking a brake disk of a front wheel, and includes a caliper body, two brake pads, and an anti-dead-lock device. The caliper body has a vertical passage adapted to permit extension of the brake disk of the front wheel therein, a fluid reservoir replete with a hydraulic fluid, and two brake-pad mounting pieces mounted on the caliper body in such a manner that the brake-pad mounting pieces are adapted to be disposed on two sides of the brake disk. The brake pads are mounted securely and respectively on the brake-pad mounting pieces of the caliper body, and are operably associated with the fluid reservoir in such a manner that when a pressure is applied on the hydraulic fluid in the fluid reservoir, the brake pads will move toward each other. The lock device includes a cylinder, a piston member, and an urging member. The cylinder defines a chamber. The piston member is disposed sealingly and movably in the chamber to divide the chamber into first and second partitions. The first partition is replete with the hydraulic fluid, and is in fluid communication with the fluid reservoir. The urging member is disposed in the second partition and abuts against the piston member. The piston member moves in a direction from the first partition toward the second partition when the pressure applied on the hydraulic fluid in the fluid reservoir overcomes an urging force provided by the urging member, thereby reducing an effective pressure acting on the hydraulic fluid in the fluid reservoir.

With the brake assembly of the present invention, the aforesaid dead-lock drawbacks encountered in the prior art can be eliminated.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partly sectioned, fragmentary schematic view of a conventional bicycle brake assembly;

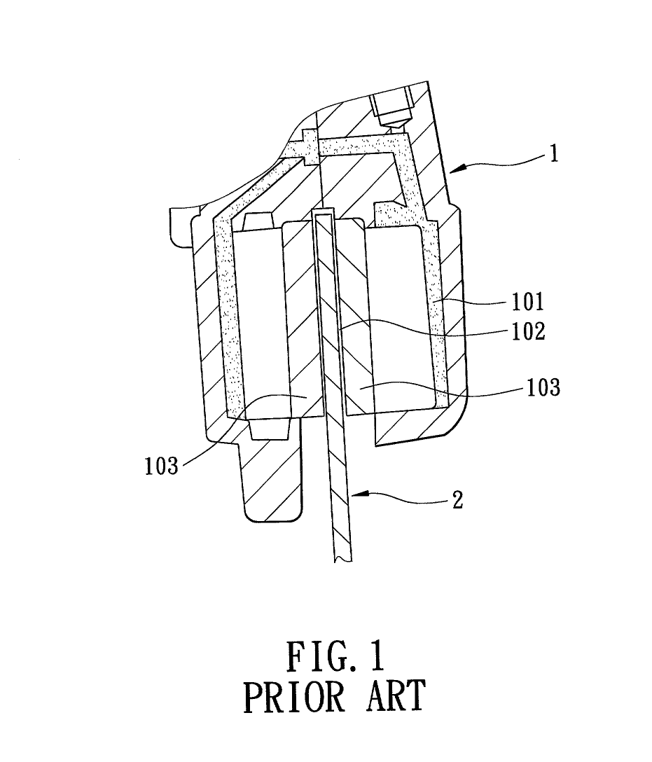

FIG. 2 is a schematic view of a first preferred embodiment of a bicycle brake assembly of the present invention;

FIG. 3 is a sectional view showing the first preferred embodiment in a non-brake state;

FIG. 4 is a sectional view showing the first preferred embodiment at a braked state;

FIG. 5 is a fragmentary partly sectioned view of a second preferred embodiment of the bicycle brake assembly of the present invention; and

FIG. 6 is a fragmentary sectioned view of a third preferred embodiment of the bicycle brake assembly of the present invention.

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

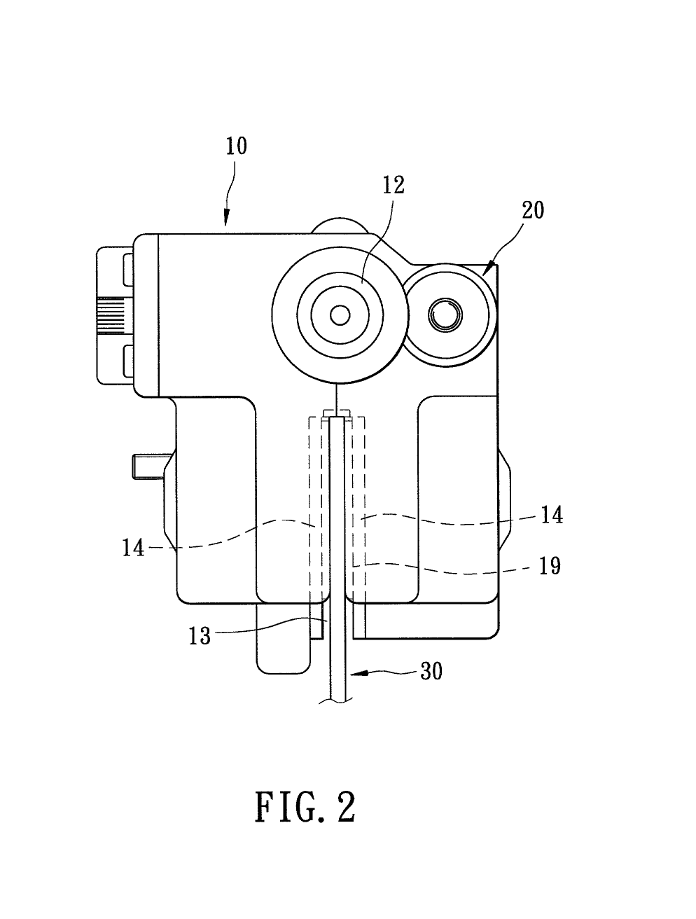

Referring to FIGS. 2, 3 and 4, the first preferred embodiment of a bicycle brake assembly of this invention is shown to include a caliper body 10 adapted to be mounted on a front fork of a bicycle (not shown) for braking a brake disk 30 of a front wheel of the bicycle (not shown), two brake pads 19, and an anti-dead-lock device 20.

As illustrated, the caliper body 10 has a vertical passage 13 adapted to permit extension of the brake disk 30 therein, a fluid reservoir 11 replete with a hydraulic fluid, and two brake-pad mounting pieces 14 mounted on the caliper body 10 in such a manner that the brake-pad mounting pieces 14 are adapted to be disposed on two sides of the brake disk 30.

The brake pads 19 are mounted securely and respectively on the brake-pad mounting pieces 14 of the caliper body 10, and are operably associated with the fluid reservoir 11 in such a manner that when a pressure is applied on the hydraulic fluid in the fluid reservoir 11 by virtue of actuation of a brake lever of the bicycle (not shown), the brake pads 19 will move toward each other, thereby clamping the brake disk 30.

The anti-dead-lock device 20 includes a first cylinder 20C, a first piston member 21, and a first urging member 22. The first cylinder 20C defines a first chamber. The first piston member 21 is disposed sealingly and movably in the first chamber to divide the same into first and second partitions 25, 26. The first partition 25 is replete with the hydraulic fluid and is in fluid communication with the fluid reservoir 11 of the caliper body 10. The first urging member 22 is disposed in the second partition 26, and abuts against the first piston member 21. Under this condition, the first piston member 21 moves in a direction from the first partition 25 toward the second partition 26 when the pressure applied on the hydraulic fluid in the fluid reservoir 11 overcomes an urging force provided by the first urging member 22, thereby reducing an effective pressure acting on the hydraulic fluid in the fluid reservoir 11, which action consequently prevents dead-lock of the brake pads 19 relative to the brake disk 30.

The anti-dead-lock device 20 further includes a first side cap 23 and a movable shaft 24. The first side cap 23 is fixed on an outer end of the first cylinder 20C, and is formed with a threaded hole. The movable shaft 24 is inserted threadedly through the threaded hole in the first side cap 23 to engage the first piston member 21. The first urging member 22 is disposed between the first side cap 23 and the first piston member 21, and has two opposite ends abutting respectively against the first side cap 23 and the first piston member 21.

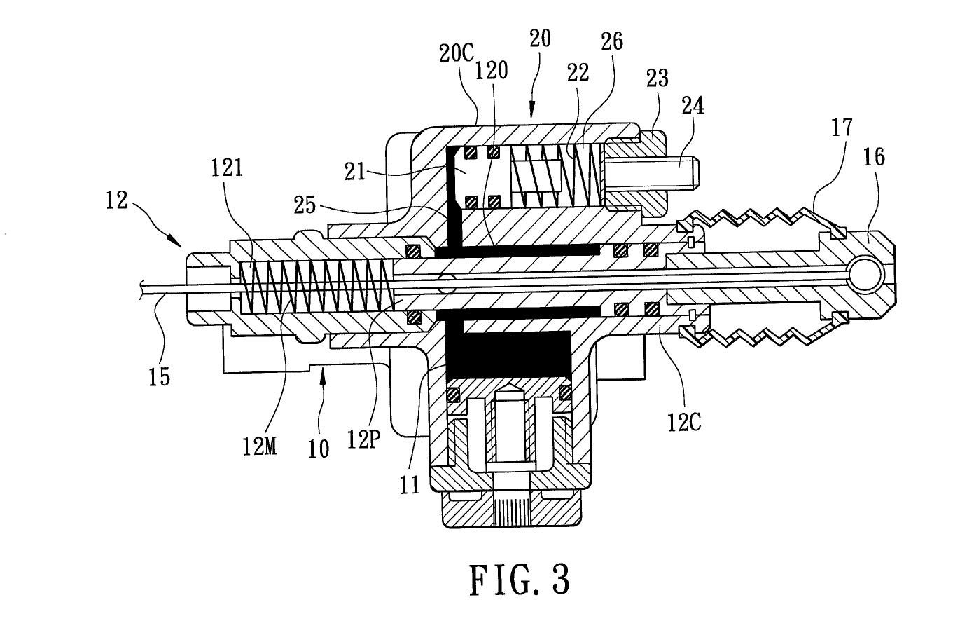

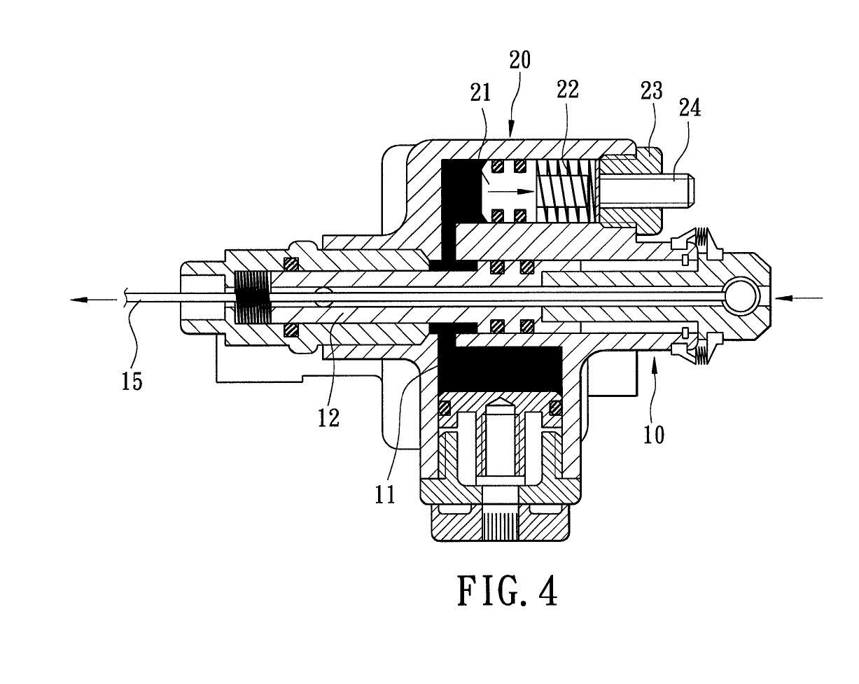

A brake actuating member 12 is employed in the first preferred embodiment, and includes a second cylinder 12C, a second piston member 12P, a second urging member 12M, a headed second side cap 16, a yoke cable 15, and a bellows-type protective sheath 17. The second cylinder 12C defines a second chamber therein. The second piston member 12P is disposed sealingly and movably in the second chamber to divide the same into third and fourth partitions 120,121 in such a manner that the third partition 120 is replete with the hydraulic fluid, and is in fluid communication with the fluid reservoir 11. Thus, movement of the second piston member 12P in a direction from the third partition 120 toward the fourth partition 121 results in the pressure acting on the hydraulic fluid in the fluid reservoir 11. The second urging member 12M is disposed in the fourth partition 121 for urging the second piston member 12P to move in a direction from the fourth partition 121 toward the third partition 120 to a normal position, i.e., when the brake disk 30 is not clamped by the brake pads 19, as best shown in FIG. 3. The second side cap 16 is mounted slidably on an outer end of the second cylinder 12C, and is connected to the second piston member 12P. The yoke cable 15 has a first end connected to the second side cap 16 and a second end adapted to be connected to a brake lever of the bicycle (not shown). Under this condition, actuation of the brake lever of the bicycle (not shown) results in movement of the yoke cable 15, which, in turn causes the movement of the second piston member 12P from the third partition 120 toward the fourth partition 121 via the second side cap 16, as best shown in FIG. 4. The bicycle provided with the brake assembly of the present invention can be prevented from skidding on the road or overturning in the event the rider suddenly pulls the brake lever in order to brake the brake disk 30 of the bicycle. The bellows-type protective sheath 17 interconnects the outer end of the second cylinder 12C and a headed end of the second side cap 16.

In the first preferred embodiment, the first and second urging members 22, 12M are compression springs. The second cylinder 12C is connected to the caliper body 10, while the first cylinder 20C is integrally formed with the second cylinder 12C.

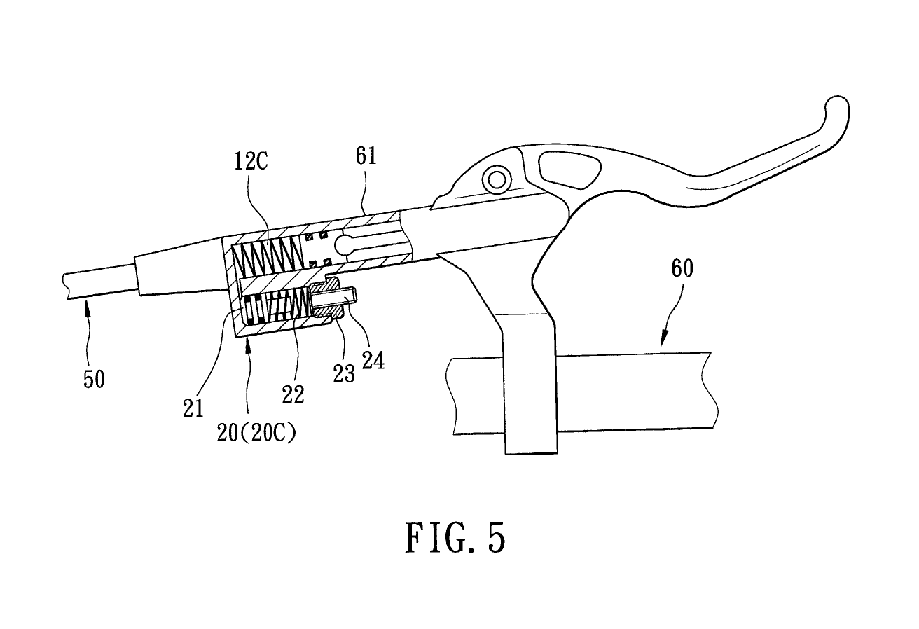

Referring to FIG. 5, a second preferred embodiment of the present invention is shown to have a structure generally similar to that of the first preferred embodiment. The main difference resides in that the second cylinder 12C is formed in a lever-mounting seat 61 of a handle bar 60 of the bicycle, while the first cylinder 20C of the anti-dead-lock device 20 is integrally formed with the second cylinder 12C. The first partition 25 of the first cylinder 20C is fluidly communicated with the third partition 120 of the second cylinder 12C and the fluid reservoir 11 (see FIG. 3) via a fluid-filled connecting pipe 50.

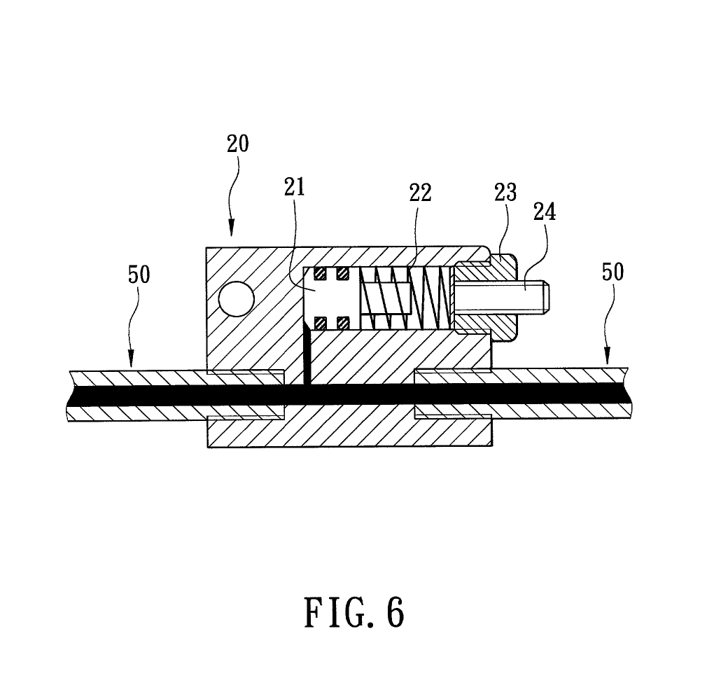

Referring to FIG. 6, a third preferred embodiment of the present invention is shown to have a structure generally similar to that of the second preferred embodiment. The main difference resides in that the first cylinder 20C of the anti-dead-lock device 20 is formed on the fluid-filled connecting pipe 50, and is fluidly communicated with the fluid reservoir 11 (see FIG. 3) via the fluid-filled connecting pipe 50.

With this invention thus explained, it is apparent that numerous modifications and variations can be made without departing from the scope and spirit of this invention. It is therefore intended that this invention be limited only as indicated in the appended claims.

I claim:

1. A bicycle brake assembly adapted to be mounted on a front fork of a bicycle for braking a brake disk of a front wheel, comprising:
a caliper body having a vertical passage adapted to permit extension of the brake disk of the front wheel therein, a fluid reservoir replete with a hydraulic fluid, and two brake-pad mounting pieces mounted on said caliper body in such a manner that said brake-pad mounting pieces are adapted to be disposed on two sides of the brake disk;
two brake pads mounted securely and respectively on said brake-pad mounting pieces of said caliper body and operably associated with said fluid reservoir in such a manner that when a pressure is applied on said hydraulic fluid in said fluid reservoir, said brake pads will move toward each other; and
an anti-dead lock device including a first cylinder defining a first chamber, a first piston member disposed sealingly and movably in said first chamber to divide said first chamber into first and second partitions, said first partition being replete with said hydraulic fluid and being in fluid communication with said fluid reservoir, and a first urging member disposed in said second partition and abutting against said first piston member;
whereby, said first piston member moves in a direction from said first partition toward said second partition when the pressure applied on said hydraulic fluid in said fluid reservoir overcomes an urging force provided by said first urging member, there by reducing an effective pressure acting on said hydraulic fluid in said fluid reservoir.

2. The bicycle brake assembly as defined in claim 1, wherein said anti-dead lock device further includes a first side cap fixed on an outer end of said first cylinder and formed with a threaded hole, and a movable shaft inserted threadedly through said threaded hole in said first side cap and engaging said first piston member, said first urging member being disposed between said first side cap and said first piston member and abutting against said first side cap.

3. The bicycle brake assembly as defined in claim 1, further comprising:
a brake actuating member including a second cylinder defining a second chamber, and a second piston member disposed sealingly and movably in said second chamber to divide said second chamber into third and fourth partitions, said third partition being replete with said hydraulic fluid and being in fluid communication with said fluid reservoir;
whereby, movement of said second piston member in a direction from said third partition toward said fourth partition results in the pressure acting on said hydraulic fluid in said fluid reservoir.

4. The bicycle brake assembly as defined in claim 3, wherein said brake actuating member further includes a second urging member disposed in said fourth partition for urging said second piston member to move in a direction from said fourth partition toward said third partition.

5. The bicycle brake assembly as defined in claim 4, wherein said brake actuating member further includes a headed second side cap slidably mounted on an outer end of said second cylinder and connected to said second piston member, and a yoke cable having a first end connected to said second side cap and a second end adapted to be connected to a brake lever of the bicycle;
whereby, actuation of the brake lever results in movement of said yoke cable, which, in turn causes the movement of said second piston member from said third partition toward said fourth partition via said second side cap.

6. The bicycle brake assembly as defined in claim 5, wherein said brake actuating member further includes a bellows-type protective sheath interconnecting said outer end of said second cylinder and a headed end of said second side cap.

7. The bicycle brake assembly as defined in claim 3, wherein said second cylinder is connected to said caliper body, while said first cylinder is integrally formed with said second cylinder.

8. The bicycle brake assembly as defined in claim 3, wherein said second cylinder is adapted to be connected to a handle bar of the bicycle, while said first cylinder is integrally formed with said second cylinder.

9. The bicycle brake assembly as defined in claim 3, wherein each of said first and second urging members is a compression spring.
